(19) United States
(12) Patent Application Publication
(10) Pub. No.: US 2011/0258907 A1
(43) Pub. Date: Oct. 27, 2011

(54) BAITED TRAP

(75) Inventors: Stefan Endepols, Burscheid (DE); Stefan Burde, Leverkusen (DE)

(73) Assignee: BAYER CROPSCIENCE AG, Monheim (DE)

(21) Appl. No.: 12/305,750

(22) PCT Filed: Jun. 19, 2007
(86) PCT No.: PCT/EP2007/005370

§ 371 Date: Jun. 15, 2011

(30) Foreign Application Priority Data
Jun. 20, 2006 (DE) 10 2006 028 722.3

(51) Int. Cl. A01M 25/00

(52) U.S. Cl. 43/131

(57) ABSTRACT

The invention relates to a bait box (1) with means for accommodating a bait or with an accommodated bait (4) in the bait box (1), with at least one port (2, 3) for providing access for a pest, in particular for a small rodent, to the bait (4). It is distinguished by the fact that the bait box (1) is designed in such a way by the fact that it has at least one section (6) which is extendable in a telescope-like fashion from a retracted position (12) into an extended position (13), whereby the volume of the bait box (1) is enlarged. The invention furthermore relates to the use of the bait box, where, in order to activate the bait, the telescopically extendable section of the bait box is brought from the retracted position into the extended position. It furthermore relates to the use of the bait box as packaging for a bait. It furthermore relates to a method of producing the bait box.

The subject matter of the present invention relates to a disposable bait box, in particular for small rodents, associated uses and an associated preparation method.

A range of methods are employed for controlling pests. The simplest possibility, firstly, consists in applying a bait in the form of a solid or of a gel directly to the areas infested with pests, so that the pests are attracted by the bait and subsequently destroyed by the active ingredient which is present in the bait. Solid baits can simply be placed or scattered, while liquid or pasty baits are in most cases applied to suitable locations using a dosing gun or syringe. However, the disadvantage of this method is that not only the pests may come into contact with the bait, but also other animals and humans. Since the baits are, in most cases, provided with poisons, for example an anticoagulant, this is particularly undesirable when there is for example the risk that toddlers may come into contact with the poison. On the other hand, a further disadvantage is that the bait is not protected from environmental factors, therefore the bait can very rapidly lose its activity. For example, such a simple placing of a bait outside is frequently not possible since the activity of the bait subsides very quickly, for example as the result of rain or climatic factors. It is also disadvantageous that, once some time has elapsed, and when the active ingredient of the bait loses its activity, the remains of the bait must be removed.

To do away with the above-described safety problems and other disadvantages, and to ensure the activity of the bait over a prolonged period, it is known to use bait boxes in which the bait is located, so that the bait is firstly not directly accessible and secondly protected from external factors. In known bait boxes, there are firstly used disposable bait boxes, for example made of cardboard, which are disposed of after use, if appropriate together with remains of bait. Such a bait box is known for example from U.S. Pat. No. 3,750,326. Secondly, there are also known reusable bait boxes, which can be refilled with bait. Thus, WO 2005/107451 relates to a bait box made of plastic and comprising at least 1 lateral access which is adapted to the pest to be controlled, and at least 1 charging port which is located at the top and which is adapted to the filling with bait gel. U.S. Pat. No. 4,349,982 discloses a bait box made of plastic with lateral accesses and a port which is located at the top and which is suitable for replenishing the Plowable bait. DE-A 195 01 892 discloses a bait box which is open at the top, has no lateral accesses and is covered by a spaced, optionally transparent, film. WO 02/102147 and U.S. Pat. No. 5,136,803 describe bait boxes in different embodiments whose lid can be opened for replenishing the bait and for inspection, and which are equipped with additional means for fixing variable bait blocks. WO 2005/107450 relates to a bait box which is adapted to the use of bait blisters.

However, these known bait boxes have the disadvantage that they involve a complicated, and hence stable, construction in order to combine with each other the protection of the bait and the access for the pests, while simultaneously achieving sufficient stability of the bait box to external stress and to ensure frequent opening and closing. The complicated construction required for this purpose frequently entails substantial difficulties in the production, transport, storage or presentation for sale, which impose considerable resources regarding costs and labour. These boxes are designed virtually exclusively for professional users.

Accordingly, it is the object of the present invention to provide a bait box, in particular a disposable bait box, which is distinguished by the fact that it is comparatively inexpensive to produce and is space-saving, while simultaneously ensuring sufficient protection of the bait from unauthorized external access or from adverse effects as the result of soiling and dirt.

The present object is achieved by a bait box according to the features of Patent claim 1. Advantageous embodiments are the subject matter of the dependent claims. The coordinated claims relate to advantageous uses and to a production method.

The bait box according to the invention has means for accommodating a bait or a bait accommodated in the bait box. For example, the bait is accommodated within the bait box in such a way that the falling out of the bait, for example through the at least one port, is largely ruled out. The bait takes the form of, for example, cereals embedded in paraffin together with an anticoagulant as active substance. It is furthermore provided to provide at least one port to allow a pest, in particular a small rodent, to access the bait. The bait box is distinguished by the fact that the bait box is designed in such a way that it has at least one section which is extendable in a telescope-like fashion from a retracted position into an extended position, thus increasing the volume of the bait box. Thus, when the telescopically displaceable section is displaced, the bait box retains the protection of the bait from unauthorized external access or from adverse effects as the result of soiling and dirt. Owing to the telescopic displacement, the bait box is relatively small in size before being “activated”, i.e. in the retracted position of the telescopically displaceable section, which proves to be particularly advantageous during storage, transport or presentation in shops since in particular in the latter case the space required is only limited, for reasons of expenditure. Furthermore, it has surprisingly emerged that, despite the earlier assumption that a telescopic section adversely effects the stability of the bait box, inter alia, as the result of the displaceable elements, the stability obtained is more than sufficient and greatly exceeds that of simple cardboard boxes. As a consequence, the bait is sufficiently protected from unauthorized external access, for example by toddlers, and from adverse effects as the result of soiling or dirt as the result of climatic factors. For example, the telescopically extendable section, or the increase in volume, is designed in such a way that it is only when the bait box is enlarged in the extended position that the pest, due to its dimensions, is capable of entering the box, or. The telescopic section has, for example, lateral walls which are designed to be displaceable relative to immobile walls of the bait box, or lateral walls which fold together in a concertina-like fashion.

The skilled worker has therefore not previously considered the telescope principle since he is interested in very robust boxes. Therefore, one invention is based on the finding that a telescope principle can lead to such inexpensive boxes that the box need not be reused, but takes the form of a disposable item, while simultaneously also being able to be the packaging of the control agent. In such a case, a particular longevity of the product is no longer an issue. Against this background, it is possible to employ a telescopic principle, or consider employing the latter.

If the bait box only has means for accommodating a bait, a further port for introducing the bait into the bait box may be provided. Preferably, this further port is designed so that it can be locked in.

The pests are insects, for example ants, codling moths, aphids, steelblue jewel beetle, bark beetles, German cockroach, gold pit oak splendour beetle, oak processionary moth, European oak leafroller moth, spruce web-spinning sawfly, flea, thrips, summer fruit tortrix moth, common furniture beetle, conifer sawfly, pine beauty moth, tawny-barred angle moth, little spruce sawfly, grain weevil, lice, maybug, mite, moth, nun moth, gypsy moth, Lyctus sp., termites, grape vine and grape berry moths, white fly, turnip moth, slugs and snails, or small mammals such as, for example, small rodents, such as mice or rats. The bait box is preferably designed for controlling mice or rats.

In accordance with one advantageous embodiment, the means for accommodating the bait or the bait are arranged in the telescopically extendable section, and the at least one port is arranged within the remaining section of the bait box, or vice versa. The result is that the upon displacement of the telescopically extendable section from the retracted position into the extended position, the distance between bait and the at least one port is increased. This measure, which brings about an increase in distance, makes it possible additionally to increase the protection from unauthorized external access by, for example, toddlers or from adverse effects as the result of soiling and dirt as the result of climatic factors. Furthermore, one embodiment prevents for example that a finger inserted into the port is capable of touching the bait.

In one advantageous embodiment, the bait box is sealed with the exception of the port(s) for the access of the pest. This ensures that the bait is accessible for the pest only, and, in addition, that the bait can only be reached when the bait box is destroyed with the use of force. This is because a further aspect is the finding that the bait in total should be sold in such a form that it is completely shielded from the consumer. This appears to be an important prerequisite for being able to sell a bait as a consumer article with long-term success. Furthermore, this shape of the bait box, which also constitutes the packaging, ensures that even incorrect handling cannot result in animals which are non target animals, for example sparrows, being able to reach the bait. In comparison, the cardboard boxes known from the prior art are unsuitable for reliably shielding the bait from children. Therefore, these boxes cannot meet the requirement of safely delivering the bait and of avoiding any form of incorrect handling. An important aim of the invention is precisely to ensure the safety aspect. The inventors have recognized that this aspect justifies the provision of a bait box which is slightly more expensive in comparison with a cardboard box, but economical in comparison with complicated, refillable boxes, while also approximately featuring the stability of the last-mentioned boxes.

In a further embodiment, the bait is accommodated within the bait box. To “activate” the bait box, therefore, it is only necessary to displace the telescopically extendable section. The contact of a person with the bait is therefore ruled out in a particularly safe manner. This results in a further aspect of saving costs since the bait box simultaneously constitutes packaging for the bait. This furthermore reduces the price. A further result is the finding that a particular durability and longevity of the box need not be taken into consideration. Therefore, this finding additionally contributes to being able to employ a telescopic principle.

In accordance with a further advantageous embodiment, the bait or the means for accommodating the bait are, in the retracted position of the telescopically extendable section, additionally interlocked, for example by lateral walls of the telescopically extendable section, and therefore not accessible via the port. This allows a safe locking of the port before the “activation” of the bait box to be disposed since the additional interlocking of the bait in the bait box by the telescopically extendable section can safely prevent access to the bait. To lock the telescopically extendable section in the retracted position, one embodiment provides a special locking means or a predetermined breaking point.

In a further advantageous embodiment, the telescopically extendable section, with the exception of an open side face, has the shape of a cuboid and is telescopically extendably inserted into a lateral wall of the bait box so that the open lateral face faces the inside of the bait box. As the result, the bait box can be produced in a particularly inexpensive manner due to its relatively simple geometry.

In a further advantageous embodiment, there is provided a catch for the extended position of the telescopically extendable section. This largely avoids an opening of the bait box by force.

In a further advantageous embodiment, there are provided two opposite ports in the bait box which are arranged in such a way that a view across the bait box is ensured at least in the extended position of the telescopically extendable section. For example, the bait box is elongated in the shape of a cuboid in whose small faces there are located ports in order to form a tunnel. Surprisingly, it has been shown in several field trials that such an arrangement of the ports favours the entry of the bait box by the small rodent, in particular the rat, since such an arrangement appears to work with the rodents' flight instinct.

In accordance with a further advantageous embodiment, the bait box is provided with a printable area and/or with an eyelet for hanging the box. For example, the eyelet is integrated into the bait box. These features are advantageous for example for the presentation of the bait box in shops.

In order to make the bait box inexpensive and simultaneously relatively stable and weatherproof, the bait box preferably consists of a plastic material. Furthermore, the bait box preferably consists of a biodegradable material, for example cellulose fibres. This eliminates the necessity of having to collect and dispose of the bait box after use, i.e. after the bait has been consumed. Such a bait box has the property of not having to be disposed of, even in the open, since the bait box will degrade on its own after a predetermined period of time has elapsed. Also, such a box, which consists of degradable materials, can be composted. The finding that it is possible to use degradable material, in turn, is closely related to the idea of offering a disposable product. This idea has previously not emerged in the field.

In a further advantageous embodiment, there is provided, in the bait box, a transparent section, for example in the telescopically extendable section. This allows the presence of the bait to be examined, the state of the bait or, if appropriate, the process of introducing the bait into the bait box to be examined via this section.

In one embodiment, the at least one port has a diameter of approximately 6 cm.

In a further advantageous embodiment, there are provided means for locking the telescopically extendable section in the extended position. The pushing-in of the telescopically extendable section can thereby be prevented. For example, there are provided locking noses which lock into place in the interior of the bait box behind the extended lateral walls of the telescopically extendable section, thus blocking them.

In what follows, there will be described an example of a bait box for rats: thus, the cuboid-shaped body of the bait box has a length of approximately 20 cm and a height and width of approximately 8-9 cm. The ports through which the rats enter have a diameter of approximately 6 cm and are arranged opposite each other on the small faces of the bait body. The telescopically extendable section together with the bait is arranged at the centre of a longitudinal face of the body in such a way that one has to reach at least 6 cm into the tunnel before reaching the edge of the section. This is a suitable length for ensuring child safety, that is ensuring that children cannot reach the bait with their fingers.

The invention furthermore relates to a use of the bait box in one of the above-described embodiments where, in order to activate the bait, the telescopically extendable section of the bait box is brought from the retracted position into the extended position. It furthermore relates to a use of the bait box as packaging for a bait.

It furthermore relates to a method of producing the bait box in one of the above-described embodiments, where at least parts of the bait box are produced by deep-drawing processes or injection moulding processes, preferably by deep-drawing processes and, if appropriate, a bait is introduced. In order to be able to produce the disposable article economically, for example a total of four parts are required. Firstly, there is a base plate, which is produced by the deep-drawing process. Then, there is an upper part which together with the plate forms the tunnel of the bait box. The upper part is likewise produced by the deep-drawing process. For example, plate and upper part are welded or glued together. Depending on the embodiment, the telescopically displaceable section is produced by the deep-drawing process or the injection-moulding process. The fourth part which is optionally required is the bait.

In order to simply save space with a bait box, there exists one embodiment in which a lid with at least one port, which lid is mounted rotatably on an essentially flat base plate with a bait, so that, in a closed state, it forms a bait box in which the bait is located. When the lid is flipped back, this means that the space required is kept at a minimum. In a further embodiment, the lid acts together with the packaging of the bait in such a way that the packaging is removed or opened in order to provide access to the bait in order thus to activate the latter. In this embodiment, the space requirement is the main feature.

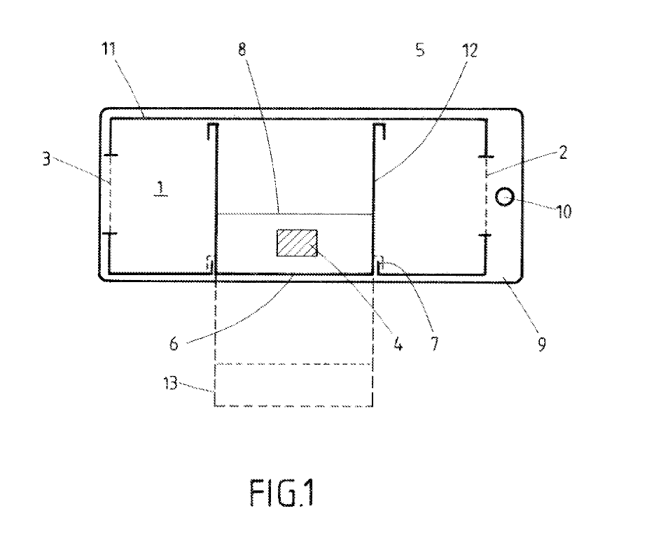

FIG. 1 shows a horizontal projection of the bait box 1 according to the invention. The base plate 9 forms the bottom of the bait box 1. Located within the base plate is an eyelet 10 for hanging up the bait box 1, in particular on a stall or shelf. An upper part, which forms the lateral walls 11 and the lid of the bait box, is glued or welded to the base plate 9. This gives rise to a cuboid-shaped bait box 1. The small faces of the bait box 1 contains ports 2, 3 opposite each other, through which a rodent, for example a rat, can reach the bait 4, which is arranged within the bait box 1, when the bait box 1 is in the “activated” state. A telescopically extendable section 6 is displaceably inserted into the longitudinal side wall of the bait box. The section 6 is likewise cuboid-shaped and open towards the interior of the bait box 1. The bait 4 is located at the bottom of the telescopically extendable section 6 and is extended together with the section 6 when the section 6 is displaced from the retracted position 12 into the extended position 13 (shown in broken lines). The catch 5 limits the movement of the telescopically extendable section 6. There are furthermore provided locking means 7 (only suggested in the drawing) in the shape of a detent, which prevent the pushing back of the telescopically extendable section 6 once the extended position has been reached. A bridge 8 arranged on the section 6 largely prevents the bait 4 from falling out, or a facility retains the bait from above and prevents its falling out. In the retracted position 12, the bait 4 is provisionally interlocked in the bait box 1 by the lateral walls of the section 6, or reaching of the bait 4 via the ports 2, 3 is prevented. In the extended position 13 (“activated” bait box), the bait 4 is accessible for a rodent, but owing to the (larger) distance between the ports 2, 3 and the bait 4, is not reachable by fingers introduced into the ports 2, 3.

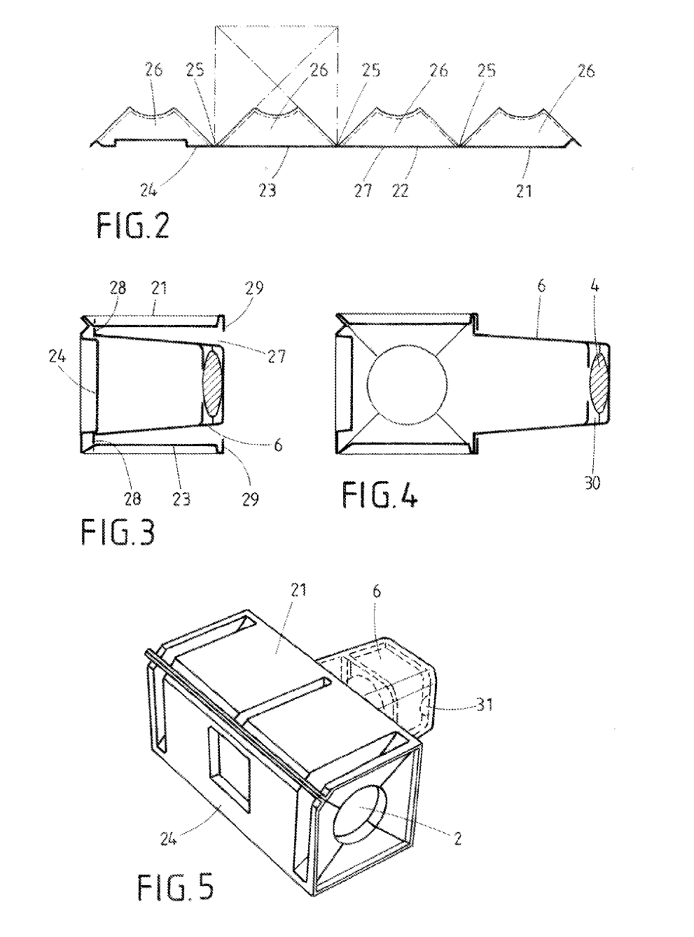

FIGS. 2 to 5 show a further embodiment of the invention. FIG. 2 shows a section across a plastic preform of which the basic structure of a bait box is formed. What is shown is a section across walls 21, 22, 23 and 24 of the basic structure to be formed. These four walls are connected to one another via predetermined bending lines 25. When the preform, which consists in particular of plastic, is bent along the predetermined bending lines by 90 degrees, and when the two correspondingly angled ends of the walls 21 and 24 are moulded or glued to each other, then a cuboidshaped structure results which has round ports 2 and 3 at two opposite walls. In order to provide such round ports 2 and 3, the walls 21, 22, 23 and 24 are provided at two appropriately opposite faces with approximately triangular sides 26. These approximately triangular sides 26 together with the walls 21, 22, 23 and 24 form in each case a right angle. However, the triangles do not form a tip as is the case with a normal triangle. Rather, they are provided with a circular cutout which is shaped in such a way that it gives rise to the ports 2 and 3 in the basic structure.

The side 22 is equipped with a rectangular cutout 27. A section of the bait box can, through this rectangular cutout 27, be extended telescopically from a retracted position into an extended position.

FIGS. 3 and 4 show a section of the bait box with the basic structure which has been formed by the preform in accordance with FIG. 2. FIG. 5 shows a three-dimensional view.

The abovementioned FIGS. 3 to 5 illustrate that the walls 21, 22, 23 and 24 are equipped with grooves and recesses which bring about the situation in which the telescopically extendable section 6 is first held in the retracted position by a press fit and, finally, in the extended position by positive locking. As shown in FIG. 3, the telescopically extendable section 6 is equipped at one end with laterally projecting plinths 28. These plinths 28 are first held by friction, that is to say by a press fit by means of recesses, which are present in the basic structure. This ensures that the telescopically extendable section 6 is not inadvertently brought from the retracted position into the extended position. The telescopically extendable section 6 tapers towards the cutout 27. Thereby, this section can be seized for example with a hand through the cutout 27 and extended. The walls of the telescopically extendable section 6 are first springably compressed during the extending process, and/or the walls 21 and 23 are first springably pressed apart. Finally, the plinths 28 arrive at the catches 29, and the extended position is reached. Here, grooves are provided into which the plinths 28 will now lock, and this in a positive manner, as shown in FIG. 4. Since the telescopically extendable section is now held by positive locking, it is ensured that the telescopically extendable section is reliably held in the extendable position. The inadvertent application of force can therefore not return the telescopically extendable section into the original position.

The telescopically extendable section 6 consists of two parts, which are shaped in a container-like fashion. Both parts taper towards the bottom of the container. The upper edge of at least one of the two containers forms the plinth 28. The two containers are inserted into one another. The internal container is shorter than the external container and is equipped at the bottom with a port. This forms a space between the two bottoms of the containers. A bait 4 which is located in a bag is introduced into this space 30. A pest can reach the bait through the port of the internal container. In this manner, the bait is retained particularly reliably, in particular when its diameter exceeds the diameter of the port of the internal container.

As shown in FIG. 5, the external container, which forms part of the telescopically extendable section 6, can additionally be equipped with recessed grips 31 in order to facilitate the grasping and extending of the telescopically extendable section 6.

In one embodiment, grooves in the walls can act together with the telescopically extendable section so that the latter is guided by the former. The correct handling of the bait box is thereby ensured to be even better.

Such a bait box is preferably supplied for example sealed within a plastic packaging. This ensures that the bait box or the bait is protected until use, for example from moisture.

The two ends of the walls 24 and 21 can be connected durably with one another by welding or gluing.

A special aspect of this embodiment is the fact that the telescopically extendable section, in its retracted position, does not extend beyond the basic structure. The result is a saleable cuboid box without projecting parts which, inter alia, facilitates the storage of such boxes.

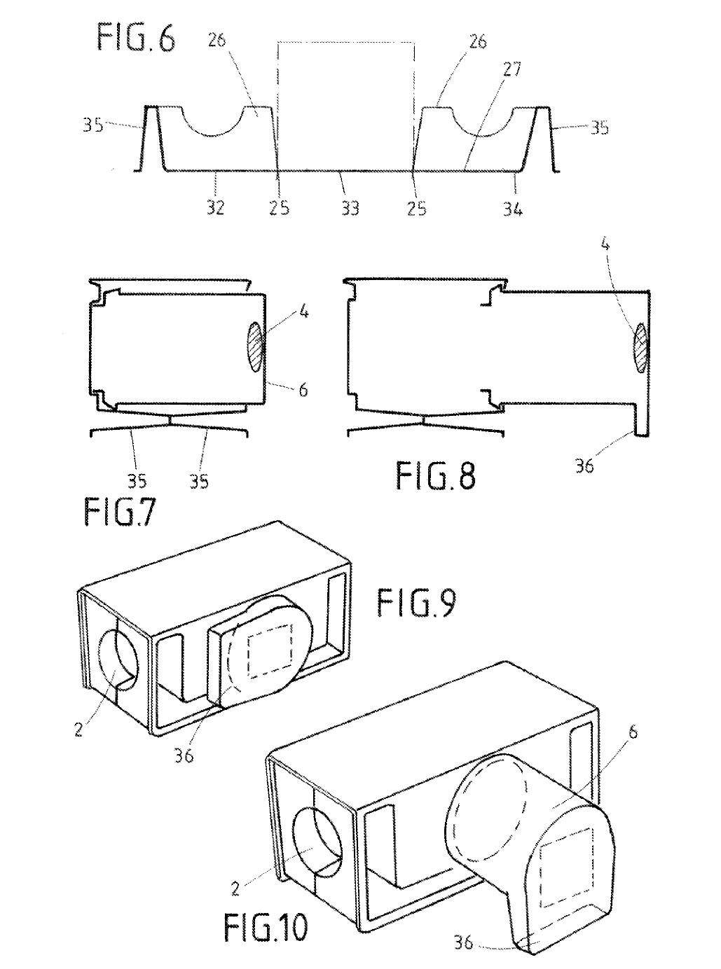

FIGS. 6 to 10 show a further embodiment of the invention.

FIG. 6 shows a preform for forming a basic structure, where only three walls 32, 33 and 34 are connected with one another via predetermined bending lines 25. Wall 34 is equipped with a circular cutout 27. The telescopically extendable section 6 is extended through the latter. A V-shaped section 35 borders the two external walls 32 and 34 at approximately right angles and is integrally connected therewith. The V-shaped sections 35 are bonded or glued to one another when the predetermined bending lines 25 are bent appropriately.

FIG. 7 shows a section of the made-up state together with a telescopically extendable section 6 located inside. The ends of the walls 32 and 34 are provided with sides 26 which are approximately rectangular and which are equipped with such a semicircular cutout that it gives rise to ports 2 and 3 when the basic structure is formed. The V-shaped sections 35 give rise to an area on which the bait box is preferably mounted.

The telescopically extendable section 6 is provided at its closed end with a lateral lever-like section 36, which is shown in FIG. 8 in the form of a section. A three-dimensional representation of the lever-like section 36 is shown in FIGS. 9 and 10.

In the retracted position, the telescopically extendable section is glued to the basic structure. The adhesive power is selected such that a motion of rotation, of the lever-like section 36, causes the joint to break. The telescopically extendable section 6 can now be extended. The lever-like section 36 is preferably rotated by 90 degrees in such a way that it simultaneously acts as a leg on which the bait box rests. This positioning of the bait box is illustrated by FIG. 10. In the embodiment according to FIGS. 6 to 10, too, the extended position of the telescopically extendable section is reached by reaching a catch.

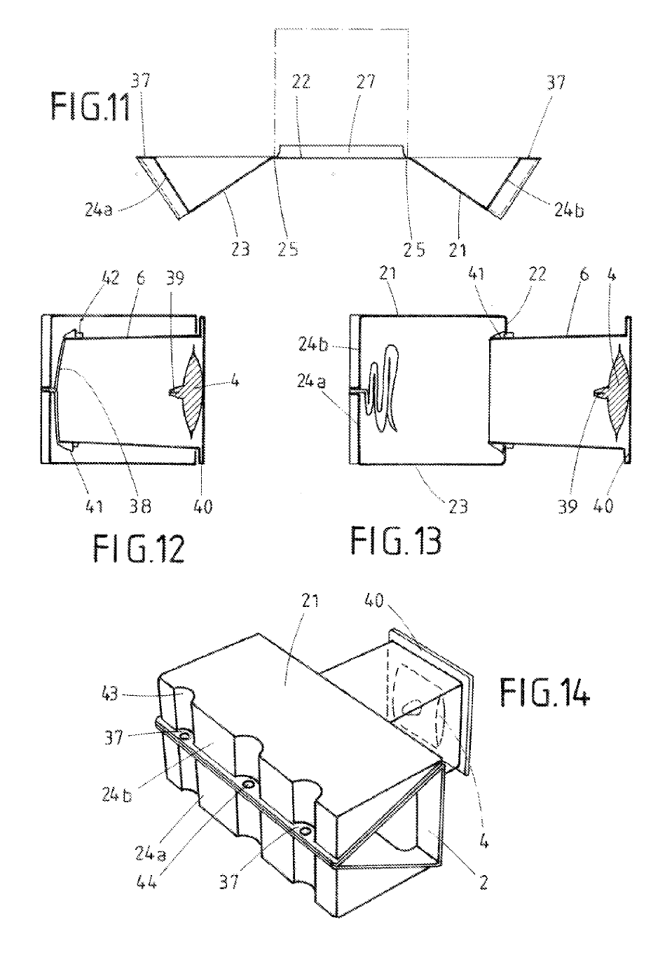

FIGS. 11 to 14 show a further embodiment of the invention. FIG. 11 shows a section across a plastic preform with two predetermined bending lines 25, from which the basic structure for a bait box is formed. The two predetermined bending lines border on a wall 22 with an approximately square cutout 27. The wall 22 with the cutout 27 is bordered by two angle-shaped sections 21, 24b and 25, 24a, respectively. The sections 21 and 23, which directly border the wall 22, form in each case one wall of the basic structure. The sections 24a and 24b, respectively, which are approximately half the length and follow at a right angle are connected to a further wall of the basic structure, for example by bonding or gluing. To this end, there are provided, at the ends of the sections 24a and 24b, zones 37 which are angled further outwardly and which are connected with one another for example by gluing or bonding. Moreover, a preferably flexible cover 38 for the telescopically extendable section 6 is tucked between the two zones 37, as shown in section in FIG. 12. The cover 38 protects the bait firstly against moisture. Moreover, the telescopically extendable section 6 is first thus retained by friction in its retracted position.

In the retracted position of section 6, marginal zones 40 of the latter sit closely on the outside of the basic structure. Again, this results in a cuboid shape without externally protruding elements. The marginal zones 40 can be grasped easily in order to pull the section 6 outwardly in a telescope-like fashion. A plinth 41, of the section 6, which protrudes externally acts as catch on the wall 22 of the basic structure when the extended position has been reached. Adjacent to the plinth 41 there is a zone 42, which brings about a friction-type fastening of the telescopically extendable section 6 in its extended position, as shown in FIG. 13.

The bait 4 has a hole in its centre. Through the hole there are pushed two internal clamping elements 39 of the telescopically extendable section 6. In this manner, the bait is suitably retained in section 6.

As shown in FIG. 14, there remains triangular open sections 2, 3 at both ends of the basic structure, through which a pest can reach the bait box. FIG. 14 furthermore makes clear that it is possible, by providing suitable recesses 43, that the angled zones 37 do not protrude externally, or only a little. The sections 37 may be provided with holes 44 in order to connect the sections 37 with one another by means of rivets or the like.

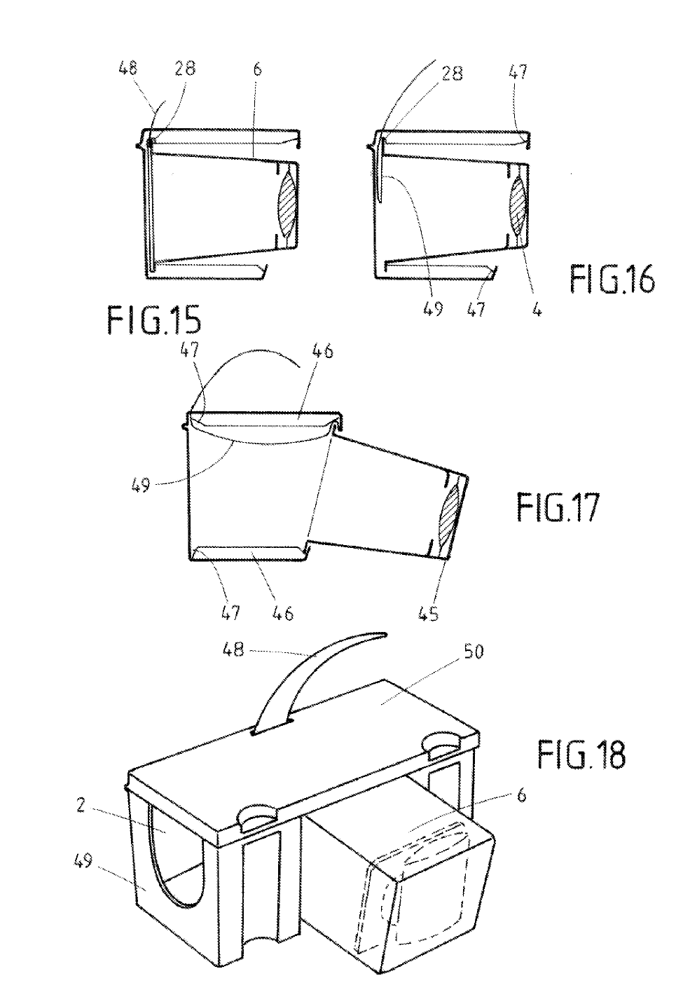

FIGS. 15 to 18 show a further embodiment. When section 6 is brought from the retracted position shown in FIG. 15 into the extended position shown in FIG. 17, the telescopically extendable section 6, once it has reached the extended position, flips downwards and reaches, with one end 45, the ground, as shown in FIG. 17. This ensures that the bait box stands stably, even when in the extended position. In agreement with the embodiment shown in FIGS. 6 to 10, this, again, ensures that the bait box does not topple when a pest or harmful animal enters section 6, thus causing the pest to run away.

Within the basic structure, there may be provided sprung elements 46, which retain the plinths 28 of section 6 both in the retracted and in the extended position positively in recesses 47 provided therefor, as shown in FIGS. 15 and 17.

A further particularity is a sealing label 48, which, by means of an initially pretensioned elastic band, is maintained in a retracted position squeezed between the basic structure and section 6, as shown in FIG. 15. When section 6 is extended a little, the sealing label 48 is no longer retained by friction and can, through a slot provided in the basic structure, be catapulted further out, caused by the elastic band 49. FIG. 16 shows an intermediate position generated thus. In this manner, it is shown whether a bait box is in the delivery state or whether it has already been activated. In this way, used bait boxes can be distinguished from unused ones, even when the section of a bait box which has already been used is returned into the retracted position in order to save space.

The basic structure shown in FIGS. 15 to 18 consists of a container 49 which has been sealed tightly with a lid 50.

In comparison, such a seal 48 may, in a further embodiment, which is not shown, be pulled into the basic structure by extending section 6, by attaching the basic structure to section 6 in a suitable manner.

It is also possible to rotate the telescopically extendable section about an axis. For example, this telescopically extendable section forms, in top view, the segment of a circle which can be rotated about a vertical axis in such a way that it disappears in the box, or finishes with the outside. This element is sealed at the top, at the bottom and outwardly, only one face is open, at least in part. In the inactive state, the open (radial) face finishes with an internal wall of the basic structure of the bait box. The bait is only accessible from the inside of the box when this rotational movement takes place.

1. Bait box with means for accommodating a bait or with an accommodated bait in the bait box, with at least one port for providing access for a pest, in particular for a small rodent, to the bait, wherein the bait box is designed in such a way that it has at least one section which is extendable in a telescope-like fashion from a retracted position into an extended position, thus increasing the volume of the bait box.

2. Bait box according claim 1, wherein, in the telescopically extendable section, the means for accommodating the bait or the bait and the at least one port are arranged within the remaining section of the bait box, or vice versa.

3. Bait box according to claim 1, wherein the bait box is sealed with the exception of the at least one port, which is provided for the access of the pest.

4. Bait box according to claim 1, wherein the bait is accommodated with the bait box.

5. Bait box according to claim 1, wherein, in the retracted position of the telescopically extendable section, the bait or the means for accommodating the bait are additionally interlocked, for example by lateral walls of the telescopically extendable section, and thus are not accessible via the at least one port.

6. Bait box according to claim 1, wherein the telescopically extendable section, with the exception of an open side face, has the shape of a cuboid and is telescopically extendably inserted into a lateral wall of the bait box so that the open lateral face faces the inside of the bait box.

7. Bait box according to claim 1, wherein a catch is provided for the extended position of the telescopically extendable section.

8. Bait box according to claim 1, there are provided two opposite ports in the bait box which are arranged in such a way that a view across the bait box is ensured at least in the extended position of the telescopically extendable section.

9. Bait box according to claim 1, wherein the bait box is provided with a printable area and/or with an eyelet for hanging the box.

10. Bait box according to claim 1, wherein the bait box consists of a plastic material.

11. Bait box according to claim 1, wherein the bait box consists of a biodegradable material, optionally comprising cellulose fibres.

12. Bait box according to claim 1, wherein there is provided, in the bait box, a transparent section, optionally in the telescopically extendable section.

13. Bait box according to claim 1, wherein the at least one port has a diameter of approximately 6 cm.

14. Bait box according to claim 1, wherein there are provided means for locking the telescopically extendable section in the extended position.

15. Bait box according to claim 1, wherein the former comprises a basic structure formed by an integral plastic preform, which comprises nondestructively predetermined bending lines, where two end zones of the plastic preform are preferably glued or bonded with one another.

16. Bait box according to claim 1, wherein the telescopically extendable section in its retracted position is held removably by drive fit and/or by positive locking and/or by a glue, and/or in its extended position is held by drive fit and/or by positive locking.

17. Bait box according to claim 1, wherein the telescopically extendable section comprises two containers which are displaced into one another, where the bottom of the internal container comprises an opening and a space is present between the two bottoms of the containers, in which space there is located the bait, where a diameter of the bait is optionally greater than the diameter of the port.

18. Bait box according to claim 1, wherein the telescopically extendable section in its retracted position is designed in such a way that it does not project beyond a basic structure, but can be grasped with a hand, optionally with the aid of recessed grips.

19. Bait box according to claim 1, wherein the telescopically extendable section is fastened in its retracted position and is detachable by a rotational movement.

20. Bait box according to claim 1, wherein the telescopically extendable section in its retracted position is rotatable and that a leg provided on the telescope-like section for positioning the bait box is pivotable by a rotational movement.

21. Bait box according to claim 1, wherein the telescopically extendable section is such that, as the result of its extension, it flips downwards into its extended position relative to the rest of the bait box.

22. Bait box according to claim 1, wherein the former is designed in such a way that the position of a seal is altered by extending the telescopically extendable section, without the position of the seal being altered again by subsequently pushing back the telescopically extendable section.

23. A bait box according to claim 1, where, in order to activate the bait, the telescopically extendable section of the bait box is capable of being brought from the retracted position into the extended position.

24. Method of producing a bait box according to claim 1, comprising conducting a deep-drawing and/or injection moulding process where at least a part of the bait box is produced and, if appropriate, introducing a bait.

25. Packaging for a bait comprising a bait box according to claim 1.
